(19) United States
(12) Patent Application Publication
(10) Pub. No.: US 2010/0062176 A1
(43) Pub. Date: Mar. 11, 2010

(54) Boundary layer disruptive preconditioning in atmospheric-plasma process

(75) Inventors: Xin Dai, Tucson, AZ (US); Richard Ellwanger, Tucson, AZ (US); Angelo Yializis, Tucson, AZ (US)

Correspondence Address: ANTONIO R. DURANDO, 6902 N. TABLE MOUNTAIN ROAD, TUCSON, AZ, 85718-1331, US

(73) Assignee: SIGMA LABORATORIES OF ARIZONA, LLC, Tucson, AZ (US)

(21) Appl. No.: 12/283,114

(22) Filed: Sep. 9, 2008

(51) Int. Cl. B05D 3/14; B05C 9/08

(52) U.S. Cl. 427/535; 118/620

(57) ABSTRACT

The boundary layer of a substrate is exposed to a low-energy inert-gas atmospheric plasma that disrupts the layer's bonds, thereby permitting the removal of most oxygen from the surface of the substrate. The substrate is then passed through an exhaust section to remove the disrupted boundary layer prior to conventional plasma treatment. The subsequent plasma treatment is carried out in conventional manner in a substantially oxygen-free environment. As a result of the invention, the high surface-energy levels provided by plasma treatment are more lasting and plasma applications requiring a substantially oxygen-free environment are more efficient.

### BACKGROUND OF THE INVENTION

1. Field of the Invention

This invention relates generally to atmospheric glow-discharge plasma treatment for surface functionalization of moving substrates. In particular, the invention is related to a novel device for disrupting the boundary layer at the surface of the substrate prior to plasma treatment.

2. Description of the Related Art

Atmospheric plasma treatment has become common practice to enhance the surface properties of films and other structures intended for further processing, such as printing, coating with adhesives, and functionalization with chemicals for phobic or philic applications. The increase in surface energy resulting from plasma treatment greatly enhances the efficiency of the subsequent process. For example, a plasma treated film may be suitable for receiving and retaining commercial printing on its surface when the untreated film is not. Therefore, it has become standard practice to plasma treat film, in a continuous roll-to-roll process, prior to utilization in their intended applications.

It is known that atmospheric plasma can be generated at relatively low temperatures with a proper power source, the insertion of a dielectric layer between the electrodes, and the use of an appropriate gas mixture as the plasma medium. For surface treatment of polymer films, fabrics, paper, etc., atmospheric plasma can be established between two electrodes using an inert gas such as helium under particular operating conditions. Usually one electrode is attached to a high voltage power supply and the other electrode consists of a grounded rotating drum. One electrode is coated with a ceramic layer and the plasma gas is injected between the electrodes. Examples of such glow-discharge plasma systems operating at atmospheric pressure are described in U.S. Pat. Nos. 5,387,842, 5,403,453, 5,414,324, 5,456,972, 5,558,843, 5,669,583, 5,714,308, 5,767,469, and 5,789,145.

U.S. Pat. No. 6,118,218, incorporated herein by reference, disclosed a plasma treatment system capable of producing a steady glow discharge at atmospheric pressure with a variety of gas mixtures operating at frequencies as low as 60 Hz. That invention involves incorporating a porous metallic layer in one of the electrodes of a conventional plasma treatment system. A plasma gas is injected into the electrode at substantially atmospheric pressure and allowed to diffuse through the porous layer, thereby forming a uniform glow-discharge plasma. As in prior-art processes, the material to be treated is exposed to the plasma created between this electrode and a second electrode covered by a dielectric layer.

U.S. Pat. No. 6,441,553, hereby incorporated by reference, disclosed an improvement as a result of the discovery that the electrodes of U.S. Pat. No. 6,118,218 could be used in conjunction with novel electrode arrangements to overcome the substrate-thickness limitations imposed by conventional plasma-treatment apparatus. By eliminating the need to maintain an electric field across the substrate being treated, the electrode assembly of the invention makes it possible to treat thick substrates and substrates of metallic composition that could not be treated with prior-art equipment. In addition, a powdery substrate can be treated by adding a shaker to a belt used to convey the substrate through the plasma field.

U.S. Pat. No. 6,441,553, hereby incorporated by reference, disclosed an atmospheric vapor deposition process carried out in combination with atmospheric plasma treatment. The substance of interest is vaporized, mixed with the plasma gas, and diffused through a porous electrode. A heater is provided to maintain, if necessary, the temperature of the electrode above the condensation temperature of the substance in order to prevent deposition during diffusion. Thus, plasma treatment and vapor deposition are carried out on a target substrate at the same time at atmospheric pressure.

U.S. Pat. No. 6,441,553, hereby incorporated by reference, describes the combination of vapor deposition and plasma treatment at atmospheric pressure using certain classes of evaporable liquid and solid materials to produce films and coatings with specifically improved barrier properties. Inasmuch as similar coatings have been produced using vapor deposition and plasma treatment under vacuum, many useful gases (i.e., vapors at ambient conditions) and vaporizable constituents are known from the prior art that can also be used advantageously in the atmospheric-pressure process of this invention (such materials are typically referred to as “precursors” in the art).

U.S. Pat. No. 6,774,018, hereby also incorporated by reference, provides a further development in the art of using atmospheric-plasma treatment to improve conventional deposition and surface treatment processes. A plasma gas at atmospheric pressure is used with various vapor precursors, such as silicon-based materials, fluorine-based materials, chlorine-based materials, and organo-metallic complex materials, to enable the manufacture of coated substrates with improved properties with regard to moisture-barrier, oxygen-barrier, hardness, scratch- and abrasion-resistance, chemical-resistance, low-friction, hydrophobic and/or oleophobic, hydrophilic, biocide and/or antibacterial, and electrostatic-dissipative/conductive characteristics.

U.S. Pat. No. 7,067,405 and U.S. Ser. No. 11/448,966, both incorporated herein by this reference, disclose various atmospheric techniques wherein plasma treatment is combined with precursor deposition and other process steps common in the art, such as curing with ultraviolet, visible, or infrared light, electron-beam radiation, and pre- and/or post-deposition plasma treatment, to further improve the final product.

Finally, U.S. Ser. No. 11/633,995, hereby also incorporated by reference, discloses a plasma treater wherein plasma is diffused at atmospheric pressure and subjected to an electric field created by two metallic electrodes separated by a dielectric material. A precursor material is introduced into the treatment space to coat a substrate film or web by vapor deposition or by atomized spraying at atmospheric pressure. The deposited precursor is exposed to an electromagnetic field (AC, DC, or plasma) and then it is cured by electron-beam, infrared-light, visible-light, or ultraviolet-light radiation, as most appropriate for the particular material being deposited.

Thus, as demonstrated by the continuous improvements achieved in the art, atmospheric plasma treatment has become a process of major importance in the commercial production of films. However, it has been found that the effect of plasma treatment (that is, the increase in surface energy of the treated surface) decreases rapidly with time, thereby reducing the value of the treatment unless immediately followed by further processing, which is sometime undesirable or impossible. For example, plasma treatment is useful when the resultant surface energy is about 45 Dynes/cm or more, which is easily achieved by appropriate plasma treatment. However, the surface energy typically drops below 40 Dynes/cm within two weeks, thereby greatly affecting its usefulness. Therefore, any improvement in the durability of the effect of plasma treatment would be a valuable advance in the art.

Another problem with current technology lies in the fact that the surface to be treated under atmospheric conditions adheres, as a result of weak bonds and van der Waals forces, to a boundary layer of air that often affects the durability of plasma treatment and/or the suitability of the substrate for a particular application. For example, it is known that thicker boundary layers produce less durable surface energy enhancements. Similarly, some processes are only effective when carried out in the absence of oxygen, such as fluorocarbon functionalization for phobic properties. Therefore, it is very desirable to minimize the presence of a boundary layer on the substrate. This is sometimes done with an inert gas knife, or by flooding the treatment area with an oxygen-free gas, or by combining flooding with subsequent removal of oxygen-rich gas from the substrate surface prior to exposure of the substrate to the plasma field. However, these mechanical approaches have limited efficacy against the weak bonds and van der Waals forces naturally present at each surface boundary.

Furthermore, as the speed of the substrate passing through the plasma treater increases, it is known that the thickness of the boundary layer at the surface of the substrate also increases, thereby further aggravating the problem. Because the speed of plasma treatment on moving webs is a critical component of production and commercial operations continue to rely on larger and larger treatment units, a solution to this problem is an essential factor for the progressive viability of plasma treatment in large unit operations. The present invention provides a material improvement to that end.

### BRIEF SUMMARY OF THE INVENTION

The invention lies in the discovery that exposure of the boundary layer of a substrate to a low-energy inert-gas atmospheric plasma disrupts the layer's bonds, thereby permitting the removal of most oxygen from the surface of the substrate. Accordingly, the substrate is first passed through a disruptive plasma electrode and then through a gas exhaust section prior to conventional plasma treatment. The substrate can then be plasma treated in conventional manner in a substantially oxygen-free environment.

Therefore, the preferred embodiment of the invention consists of the combination of two plasma electrodes separated by an exhaust section placed inline over a substrate continuously moving over a conventional drum from roll to roll for atmospheric plasma treatment. The first, disruptive electrode is operated at relatively low energy in an inert-gas atmosphere, preferably nitrogen, over the moving substrate. This plasma exposure is designed to disrupt the bonds between the air boundary layer and the surface of the substrate without actually treating the substrate. Note that plasma treatment in the art is understood to mean exposure to a plasma gas under sufficient energy activation to break and reform bonds on the surface of the substrate (i.e., clean and functionalize). In contrast, plasma disruption, as produced by the disruptive electrode of the invention, is intended to mean exposure to a plasma gas under an energy activation level sufficiently high to activate and disrupt the bonds in the boundary layer and between the boundary layer and the surface of the substrate, but not so high as to also treat the surface (as treatment is defined above). Therefore, these definitions are adopted herein for the purpose of distinguishing the plasma disruptive electrode and process from the plasma treatment electrode and process.

Inasmuch as two distinct energy levels of operation are required for the two plasma electrodes of the invention, the use of two separate power supplies is preferred. After processing of the substrate through the initial disruptive electrode, the exhaust section is used to remove the disrupted boundary layer from the surface of the substrate immediately prior to plasma treatment. Finally, the substrate is treated conventionally with a higher-energy plasma treater and a specific plasma gas mixture chosen to add the desired functionality to the surface.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose only some of the various ways in which the invention may be practiced.

### BRIEF DESCRIPTION OF THE DRAWINGS

FIG. 1 is a schematic representation of a conventional atmospheric plasma-treater configuration.

FIG. 2 is a section view of a typical electrode used in a conventional atmospheric plasma treater.

FIG. 3 is a schematic elevational view of a plasma-treater assembly including an additional low-energy electrode with an exhaust downstream gas-containment section according to the invention.

FIG. 4 is a schematic view of the plasma-treater assembly of the invention also showing the separate power sources preferably used to energize the low-energy electrode and the plasma-treatment electrode.

FIG. 5 is perspective view of the plasma-treater assembly of FIG. 3 installed on a drum for atmospheric roll-to-roll operation.

FIG. 6 is a plot showing the relative oxygen and nitrogen content of a BOPP (biaxially oriented polypropylene) film treated with a conventional atmospheric plasma treater in an air plasma.

FIG. 7 is a plot showing the relative oxygen and nitrogen content of the same BOPP film treated in the conventional atmospheric plasma treater with a nitrogen plasma.

FIG. 8 is a plot showing the relative oxygen and nitrogen content of the same BOPP film treated with the plasma electrode assembly of the invention, showing a marked reduction in the boundary layer oxygen produced by the layer disruption electrode and exhaust section of the invention.

### DESCRIPTION OF THE PREFERRED EMBODIMENTS OF THE INVENTION

This invention adds a plasma electrode and an exhaust section to any of the plasma-treatment processes and equipment described in the prior art to further improve the surface properties of substrates manufactured by plasma-enhanced applications. Accordingly, the invention may be carried out using the various embodiments of the apparatus described in the above-referenced disclosures, which are herein incorporated by reference in their entirety, as well as in related processes and apparatus.

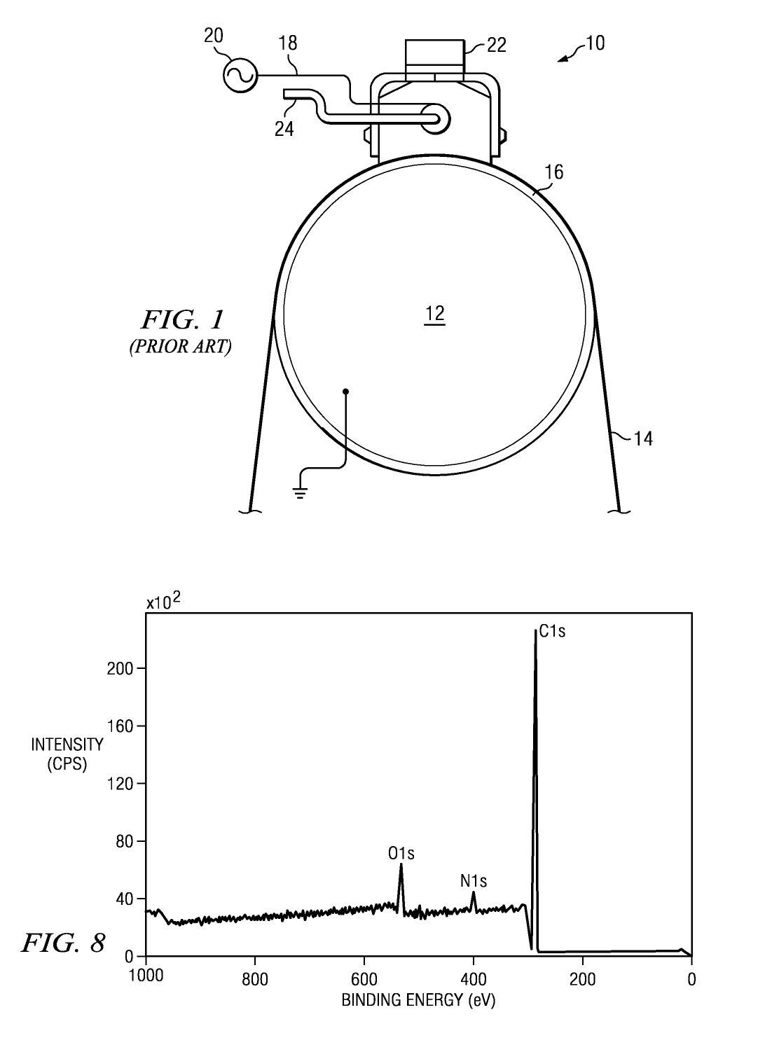

Referring to the drawings, wherein like parts are designated throughout with like numerals and symbols, FIG. 1 shows a general layout of an atmospheric plasma treater assembly wherein a plasma treater 10 is shown mounted opposite to the roller 12 of a conventional web-treatment system. A web or film 14 of material to be treated is passed through the assembly between the plasma treater and the roller at speeds typically ranging from 1 to 200 meter/min. The roller 12 is grounded and coated with a dielectric material 16, such as polyethylene teraphthalate (PET). The plasma treater 10 contains at least one electrode as described in U.S. Pat. No. 6,118,218, which is connected, through a cable 18, to an AC power supply 20 operating at any frequency between 60 Hz and the maximum frequency available from the power supply. The treater 10 is held in place conventionally by a holding bracket 22 to maintain a distance of 1-2 mm between the dielectric layer 16 and the treater 10. Plasma gas, such as helium, argon, and mixtures of an inert gas with nitrogen, oxygen, air, carbon dioxide, methane, acetylene, propane, ammonia, alkyl silanes, siloxanes, fluorocarbons, or mixtures thereof, can be used with this treater to sustain a uniform and steady plasma at atmospheric pressure. The gas is supplied to the treater 10 through a manifold 24 that feeds the porous electrode of the invention.

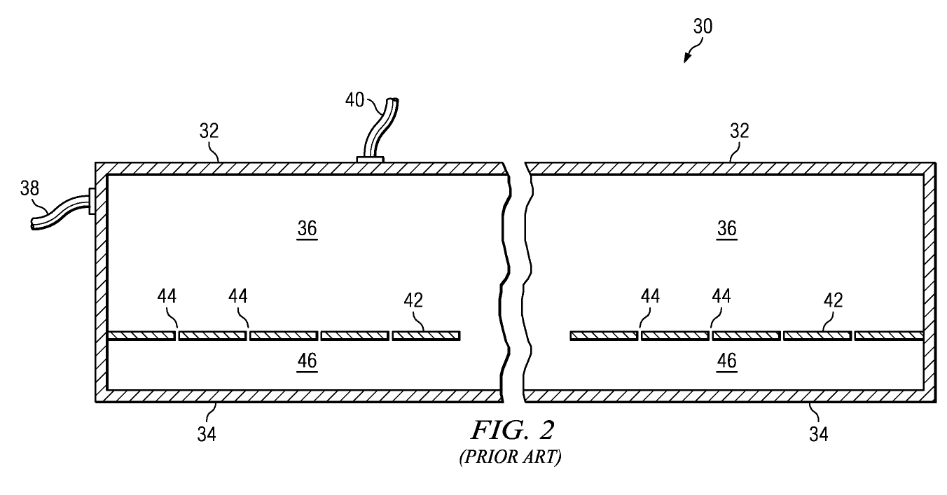

As shown in FIG. 2, a porous plasma-treatment electrode 30 incorporated within the treater 10 may consist of a hollow housing 32 with a porous metal layer 34 for diffusing the plasma gas into the treater. The gas is fed to the upper portion 36 of the hollow electrode 30 at substantially atmospheric pressure through an inlet pipe 38 connected to the exterior manifold 24. The electrode is energized by an electrical wire 40 connected to the power system through the exterior cable 18. The electrode 30 preferably includes a distribution baffle 42 containing multiple, uniformly spaced apertures 44 designed to distribute the gas uniformly throughout the length of the bottom portion 46 of the hollow electrode 30.

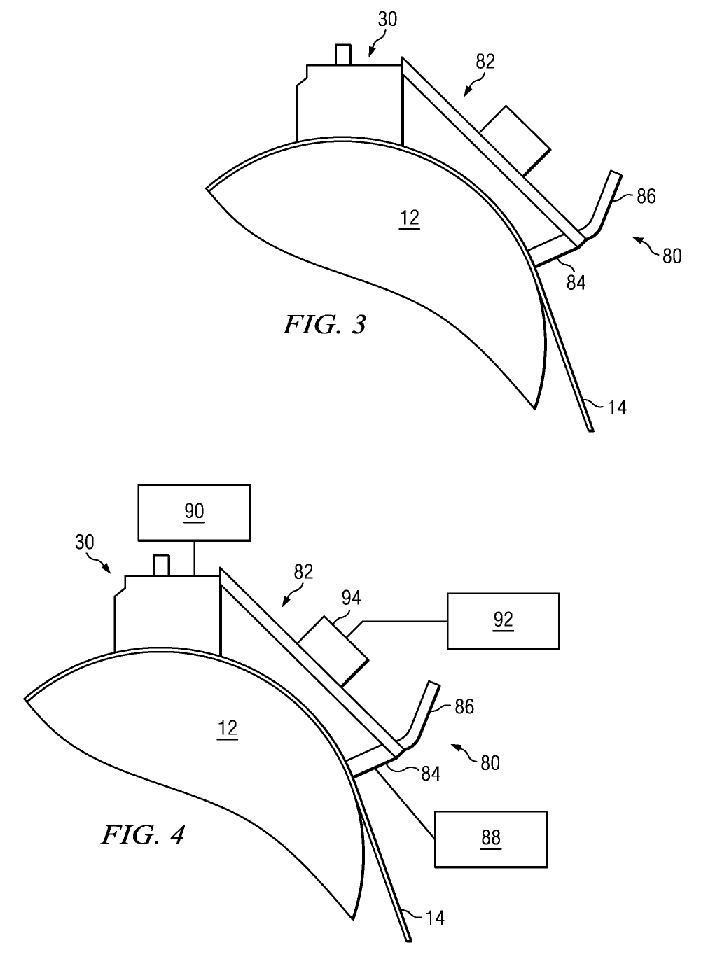

In the alternative, any one of several embodiments of porous electrode can be used to practice the present invention. To that end, the plasma-treatment electrode 30 of FIG. 1 is coupled to a low-energy disruptive plasma electrode 80 and an enclosed exhaust section 82, as illustrated in the schematic elevational view of FIG. 3. The disruptive electrode 80 also includes an integrated gas manifold 84 facing the process space for delivering plasma gas over the substrate 14 to be treated. A port 86 is provided for delivering plasma gas into the hollow interior of the electrode 80 under a pressure suitably controlled to provide the required flow rate of plasma gas to the process space. The disruptive electrode 80 is energized by a power supply 88, seen in FIG. 4, preferably separate from the power supply 90 used to energize the higher-energy electrode 30. The energy supplied to the electrodes is controlled by varying the voltage and/or the current provided to them. While the same power supply could be used with appropriate resistive circuitry to energize both electrodes 30 and 80 at different energy levels, it was found that the precise control required for good results is achieved much more successfully with independent power supplies.

As those skilled in the art will readily understand, atmospheric plasma treatment is typically carried out at energy levels grater than 0.1 joules/cm² of treated surface (in the range of 0.2-5 joules/cm²), depending on the substrate and application. Therefore, for the purposes of this disclosure, “high-energy” is intended to mean energy levels of 0.2-5 joules/cm²). On the other hand, the energy required for disrupting the air boundary layer according to the invention has been found to be about 0.1 joules/cm². Therefore, for the purposes of this disclosure the term “low-energy” is intended to mean energy levels of 0.1 joules/cm² or less. However, as mentioned above, the distinction between a disruptive plasma electrode and a plasma-treatment electrode is made more precisely on the basis of the effect the exposure to the plasma has on the target. Therefore, as it relates to the electrode and to the process, “treatment” is use herein to mean exposure to a plasma gas under sufficient energy activation to break and reform bonds on the surface of the substrate. In contrast, “disruption” and “disruptive” are intended to mean exposure to a plasma gas under an energy activation level sufficiently high to activate and disrupt the bonds in the boundary layer and between the boundary layer and the surface of the substrate, but not so high as to also treat the surface.

Thus, for the purposes of the invention it important that the plasma disrupting electrode 80 be operated at an energy level below what is required for plasma treating the particular substrate being processed. Otherwise, the substrate will be functionalized with boundary layer molecules, such as oxygen, which may be highly undesirable.

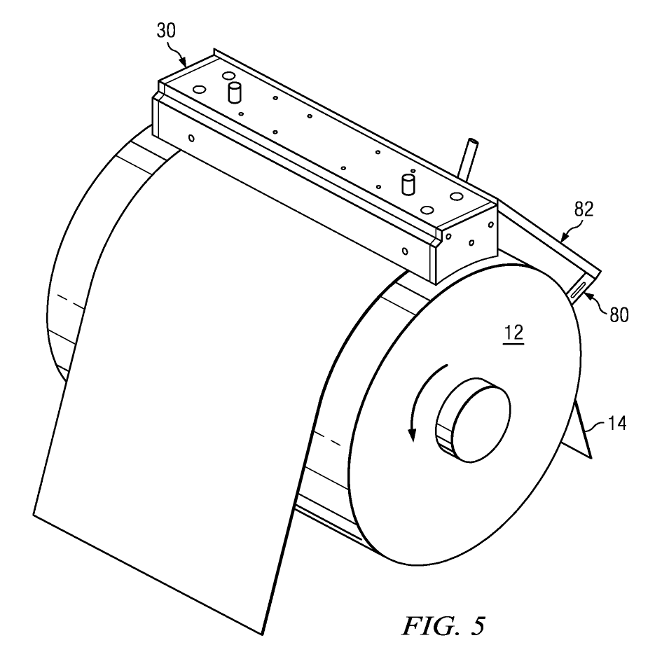

As illustrated schematically in FIG. 4, after processing through the disruptive electrode 80, the substrate 14 is passed through the exhaust section 82, which is connected to a downstream gas-removal device, such as an exhaust blower 92, by means of a port 94 and appropriate piping for removing the disrupted boundary-layer gases from the process space. The exhaust blower 92 is operated so as to provide a sufficient pressure gradient to draw the disrupted boundary-layer gases out of the exhaust section 82. For example, a negative pressure differential (or low-vacuum) of about one inch of water is sufficient to practice the invention successfully. A positive pressure differential with injection of an inert gas would also work, but it is not preferred. The substrate is then passed through the plasma-treatment electrode 30 for conventional treatment. FIG. 5 is a perspective view of the plasma assembly of the invention installed on a conventional drum for continuous roll-to-roll operation.

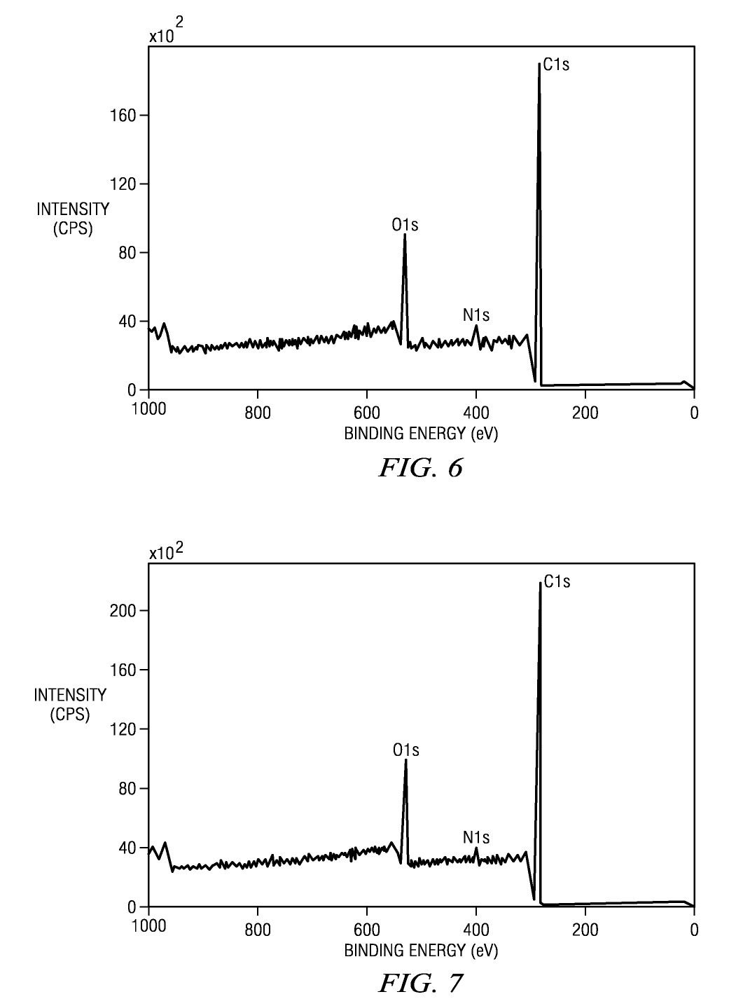

The processing of the substrate 14 through by the plasma in the disruptive electrode 80 and the exhaust section 82 enables the removal of enough boundary layer to materially enhance the efficacy of the subsequent plasma treatment. For example, FIGS. 6-8 show a comparison of XPS (X-ray photoelectron spectroscopy) results obtained from the same BOPP (biaxially oriented polypropylene) substrate under different treatment conditions. FIG. 6 is a plot showing the relative oxygen and nitrogen content in the BOPP film after plasma treatment with a conventional atmospheric plasma treater using air (that is, without injecting any other plasma gas through the treatment electrode). FIG. 7 shows the same plot when the BOPP film is treated in the same conventional atmospheric plasma treater using nitrogen gas. The plot shows very little change in the relative oxygen and nitrogen content with respect to plasma treatment in air. FIG. 8 illustrates the effect of the present invention. When the same BOPP film is first passed through the disruptive electrode and exhaust section of the invention and then treated conventionally with nitrogen plasma, the plot shows a marked reduction in the boundary layer oxygen elative to the nitrogen still present on the surface of the substrate.

Similarly, tests have shown also that disrupting and removing the boundary layer prior to plasma treatment increases significantly the efficiency of applications that ideally should be carried out in the absence of oxygen. Foe example, the adhesive property of a film coated with adhesive chemicals having such reaction characteristics were greatly enhanced by the disruptive process of the invention.

Thus, a new device and process have been disclosed that improve the efficacy of conventional plasma treatment, as evidenced by the XPS plots of FIGS. 6-8. In particular, the disruptive plasma electrode and exhaust section of the invention, when followed with the appropriate downstream plasma treatment, have been found to extend the high surface-energy effect of plasma treatment way beyond the one-to-two-week effect previously recorded. In addition, and most importantly for treatment applications requiring a low- or no-oxygen environment, the boundary-layer disruptive process of the invention has shown to materially reduce the presence of oxygen in the treatment space.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

1. A method of plasma treating comprising the following steps:
exposing a substrate to a disruptive plasma electrode operating in an inert-gas atmosphere;
passing the substrate through an exhaust section connected to a gas-removal device; and
immediately exposing the substrate to a plasma-treatment electrode operating in a gas atmosphere selected for a particular application of interest.

2. The method of claim 1, wherein said inert-gas atmosphere is a nitrogen atmosphere.

3. The method of claim 1, wherein said gas-removal device is a blower placed downstream of the exhaust section.

4. A plasma treater comprising:
a disruptive plasma electrode connected to a source of inert plasma gas and facing a substrate undergoing treatment;
an exhaust section adjacent to the disruptive plasma electrode and connected to a gas-removal device so as to provide exhaustion of gases over the substrate;
a plasma-treatment electrode connected to a source of gas selected for a particular application of interest and facing the substrate, said plasma-treatment electrode being adjacent to the exhaust section for immediate plasma treatment of the substrate after exposure to the exhaust section; and
means for energizing the disruptive plasma electrode and the plasma-treatment electrode at different energy levels.

5. The plasma treater of claim 4, wherein said inert plasma gas is nitrogen.

6. The plasma treater of claim 4, wherein said means for energizing includes two separate power supplies.

7. The plasma treater of claim 4, wherein said gas-removal device is a blower placed downstream of the exhaust section.
